(19) United States
(12) Patent Application Publication
(10) Pub. No.: US 2025/0273868 A1
(43) Pub. Date: Aug. 28, 2025

(54) RECONFIGURABLE REFLECTOR FOR BICONICAL ANTENNA

(71) Applicant: Massive Light LLC, Spring, TX (US)

(72) Inventor: Bernd Strassner, II, Albuquerque, NM (US)

(21) Appl. No.: 19/066,446

(22) Filed: Feb. 28, 2025

Related U.S. Application Data
(60) Provisional application No. 63/558,752, filed on Feb. 28, 2024.

(51) Int. Cl. H01Q 15/14; H01Q 1/36; H01Q 15/16

(52) U.S. Cl. CPC H01Q 15/147; H01Q 1/36; H01Q 15/16

(57) ABSTRACT

An apparatus comprising a biconical antenna for generating an omnidirectional beam pattern is presented. A reflector reflects the omnidirectional beam pattern from the biconical antenna into a predetermined beamform. The reflector comprises a ground plane connected to the biconical antenna and a parabolic reflector extending from the ground plane at a predetermined angle. A curvature of the parabolic reflector reflects the omnidirectional beam pattern into the predetermined beam form. The predetermined angle corrects for beam shift of the predetermined beam form caused by the ground plane.

### CROSS-REFERENCE TO RELATED APPLICATIONS

This application claims benefit of U.S. Provisional No. 63/558,752, filed Feb. 28, 2024, entitled RECONFIGURABLE REFLECTOR FOR BICONICAL ANTENNA (Atty. Dkt. No. MASS90-00015), the specification of which is incorporated by reference herein in their entirety.

### TECHNICAL FIELD

The following disclosure relates to antenna reflectors, and more particularly, to an antenna reflector that is reconfigurable for use with biconical antennas.

### BACKGROUND

Antennas are designed to be used for particular applications. A certain antenna will have a particular radiation pattern that enables it to be utilized for a particular purpose. In some cases, multiple antennas are needed to produce a narrow directive beam pattern in addition to an omnidirectional beam pattern. This is difficult to mobilize in the filed since multiple antennas with associated transmission equipment are needed. Having to carry a variety of different antennas for different functionalities can be prohibitive due to the weight and space required. Reconfigurability between antenna types could allow for different pattern shapes to be realized without needing a unique antenna for every pattern scenario.

### BRIEF DESCRIPTION OF THE DRAWINGS

For a more complete understanding, reference is now made to the following description taken in conjunction with the accompanying Drawings in which;

FIG. 1 illustrates a biconical antenna;

FIGS. 2A-2D illustrate various views of a reflector for use with a biconical antenna;

FIG. 3 illustrates the return losses for the biconically-fed reflector; and

FIG. 4 illustrates the measured gains of the biconically-fed reflector: and

FIGS. 5A and 5B illustrate the measured elevation gain patterns of the biconically-fed reflector;

FIG. 6A illustrates a pair of biconically-fed reflector antennas; and

FIG. 6B illustrates the group delay performance between two identical biconically-fed reflector antennas.

### DETAILED DESCRIPTION

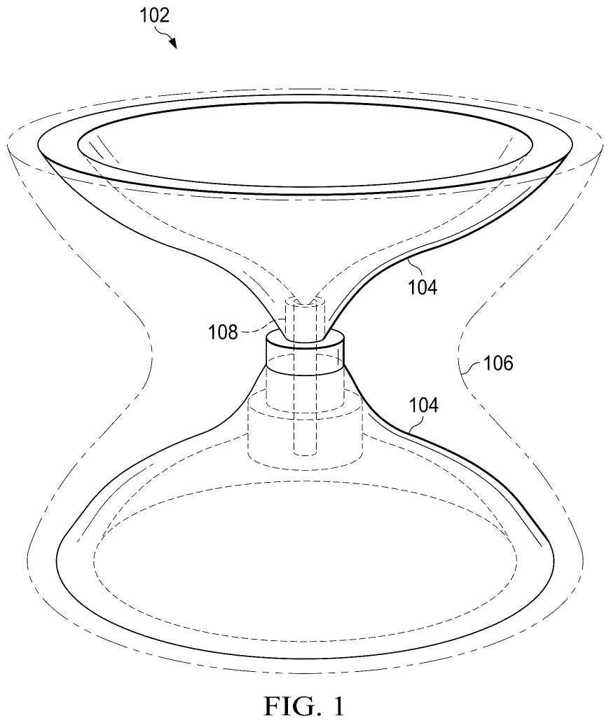

One manner for increasing the flexibility of an antenna involves the use of a reconfigurable reflector that may have an antenna installed thereon in order to alter the radiation characteristics of the antenna. Referring now to FIG. 1, there is illustrated a biconical antenna 102. The biconical antenna 102 consists of a pair of metallized cones 104 that are interconnected at the small end thereof that are surrounded by a dielectric material 106. The biconical antenna 102 includes a sinusoidal taper on the cones 104. At the connecting point between the two metallized cones 104 is a coaxially fed radiating element 108 for emitting the RF signals. The biconical feed antenna 102 has radially symmetric coverage over all ø values to the horizon. This is great for an omni-directional stand-alone unit.

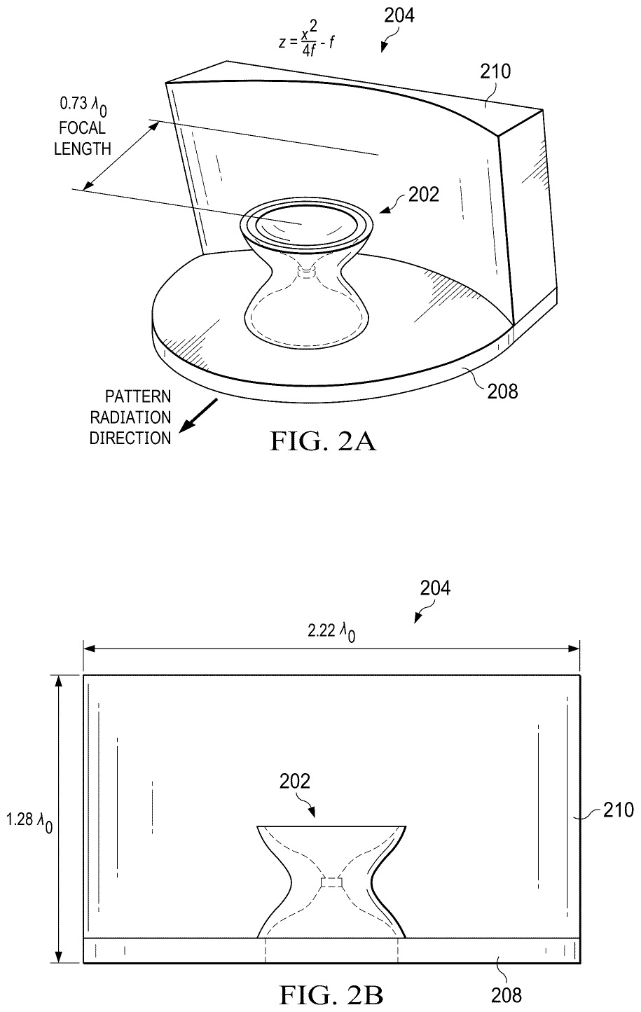

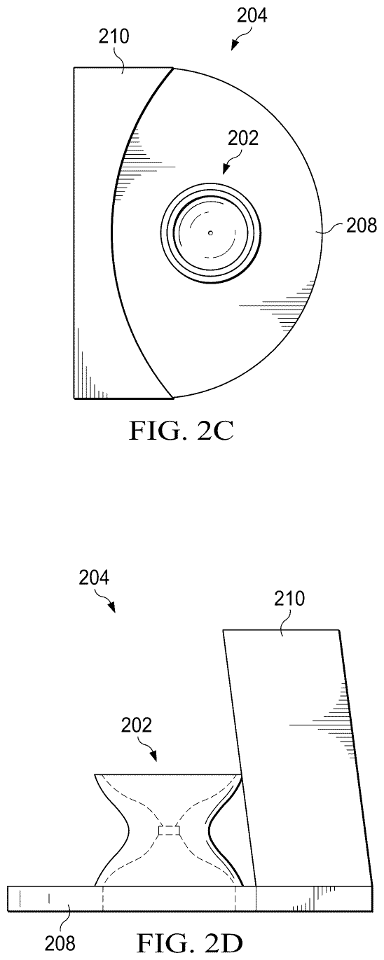

Referring now to FIGS. 2A-2D, there are illustrated various views of a biconical antenna 202 removably attached to a reflector 204. The reflector 204 comprises a metallic ground plane 208 upon which the biconical antenna 202 is removably attached. The biconical antenna 202 is connected to the ground plane 208 via a number of studs or bolts (not shown) that extend downward from the base of the antenna 202 and are connected to the ground plane 208 via nuts (not shown). Extending upward from the ground plane 208 is a tilted parabolic reflector 210. The curved face of the parabolic reflector 210 defines the beam that is reflected by the parabolic reflector. The nature of the beam can be a fan beam or narrow beam projection depending upon the particular use needed from the reflector 204. Differing types of projected beams from the reflector 204 may be achieved by switching out the reflector to another reflector having a differing curvature associated therewith. Thus, the same antenna can provide both a fan beam or a narrower beam projection depending upon the particular reflector 204 curvature illuminated by antenna 202.

The material comprising the reflector 204, ground plane 208 and tilted parabolic reflector 210 may comprise a metal. In an alternative embodiment, the reflector may comprise some non-metallic material that has a metallic coating deposited thereon.

The curvature of the parabolic reflector 210 is governed by the equation:

z=(x²)/4*f)−f

where f is the focal length of the reflector and x and z comprise Cartesian system coordinates. The “4” coefficient is normally 4 for parabolic reflectors. This gives the properly shaped beam with patterns at the desired frequencies. The focal length distance between the biconical antenna's center located central to the reflector is 0.73 λ₀ at a first frequency (center of first band) and 1.26 λ₀ at a second frequency (center of second band). At this short distance, the reflector 204 behaves in dual roles. One role is that of a parabolic reflector and the other is a traditional ground plane. The “4” coefficient can also be altered, say to 3.5, to spoil the reflector's curvature resulting in a “reconfigured” broadening of the pattern's beam that emanates from the reflector's surface.

The beam pattern projected by the reflector 204 tilts upward due to the effects of the ground plane 208. The tilt of the of the parabolic reflector 210 towards the antenna 202 enables the beam pattern projected by the reflector to be directed properly downward (horizontally) by counteracting the upward tilt to the beam pattern caused by the ground plane 208.

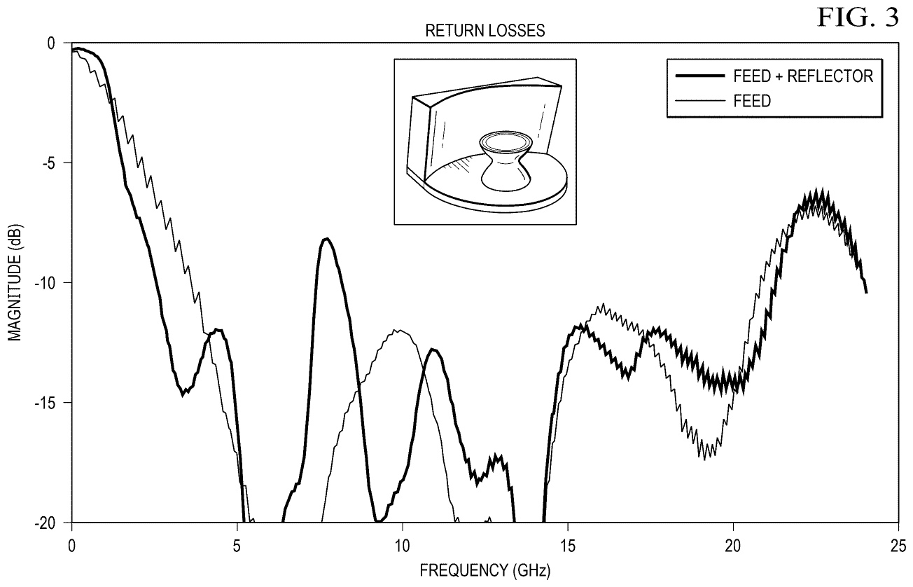

Referring now to FIG. 3, the antenna 202 and associated reflector 204 provide better than −10 dB S₁₁ return losses across the 2.5 to 21 GHz band as shown with the black curve. The gray curve shows that the bicone feed by itself is similarly matched over the 2.5 to 21 GHz band. These return losses are measured at the biconical feed's SMA input port.

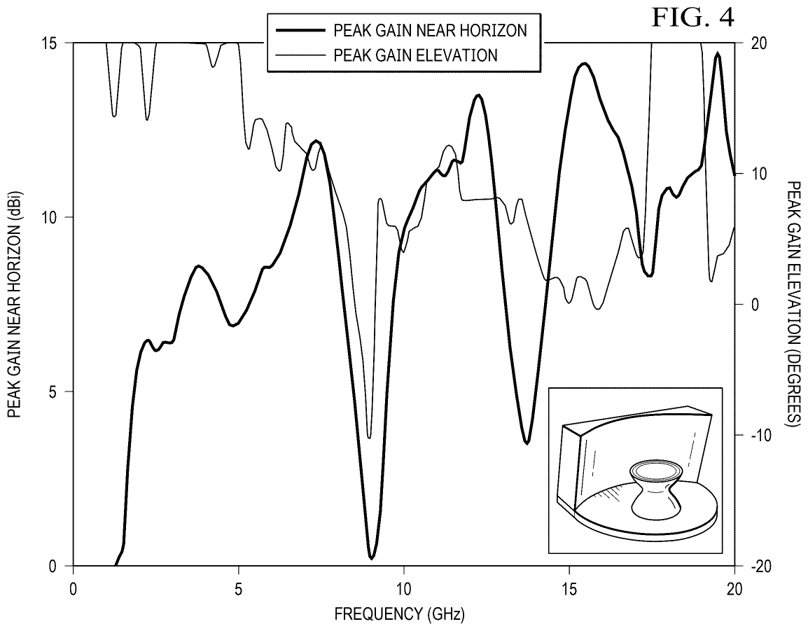

Referring now to FIG. 4, there is illustrated the peak elevation gains and the associated elevation angle measured from the horizon at which these peak gains occur. The biconical antenna 202 feed's inherent wide bandwidth allows for regions of good gains located within the 2 to 20 GHz range. The harmonic cyclic up/down nature of the peak gain over frequency is clearly seen, and this is due to the reflector 204 acting as a ground plane in close proximity to the biconical feed antenna 202. The peak gain theta locations are close to 15° for the first band (2 to 7.5 GHz), 10° for the second band (10 to 12.5 GHz), and 0° (horizon) for the third band (15 to 16.5 GHz).

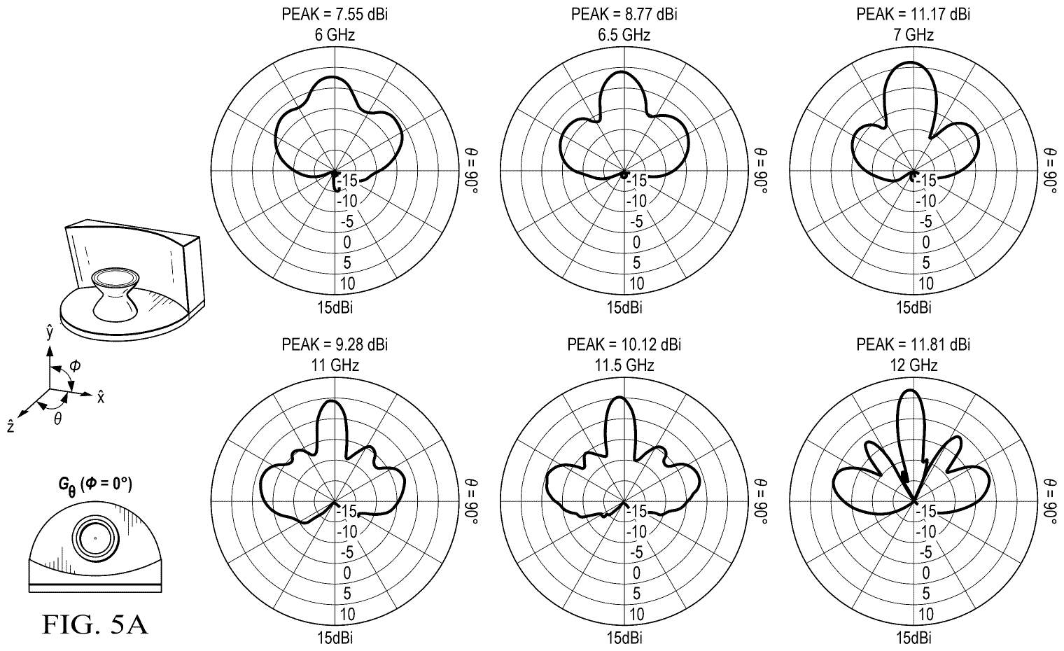

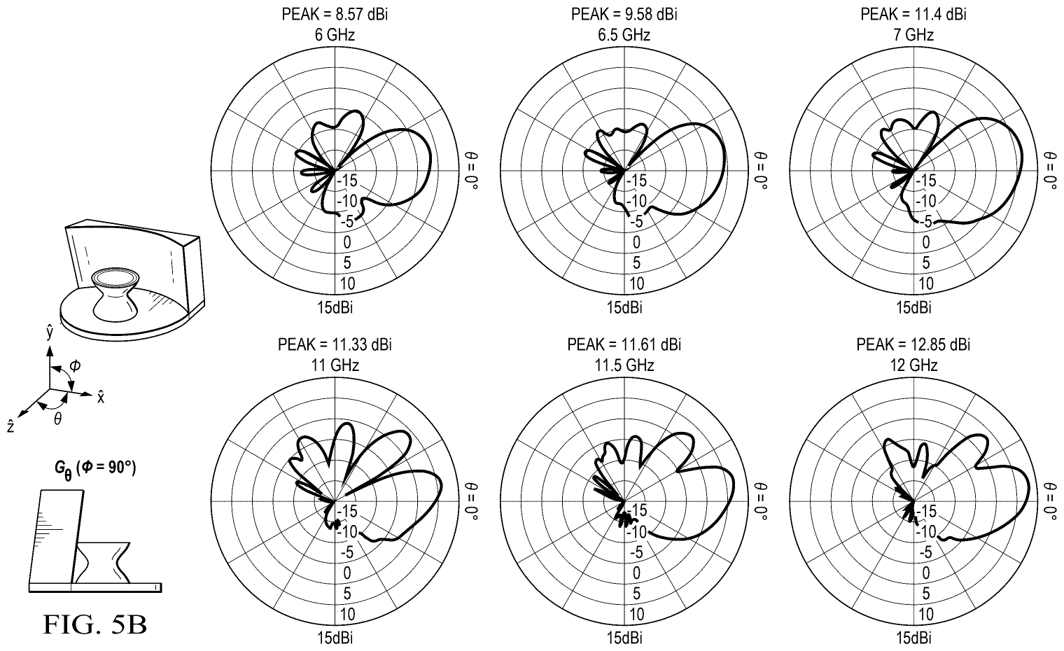

Referring now to FIGS. 5A and 5B, there are a coordinate system for describing the antenna patterns. Elevation pattern plots are presented for the bicone-fed reflector 204 corresponding to the first two bands. The G_{θ} (ϕ=0°) (FIG. 5A) patterns are more or less symmetric due to the geometric symmetric nature of that plane. The G_{θ} (ϕ=90°) (FIG. 5B) plots are close to the horizon (θ=0°). They kick up slightly due to the ground plane on which the bicone rests. The gains are close to 10 dB for all the frequencies shown. Patterns that exist at frequencies between the 0.5 GHz steps are also good. The addition of the reflector 210 in close proximity to the bicone 202 has “reconfigured” the omni-directional pattern into a much more directive pattern.

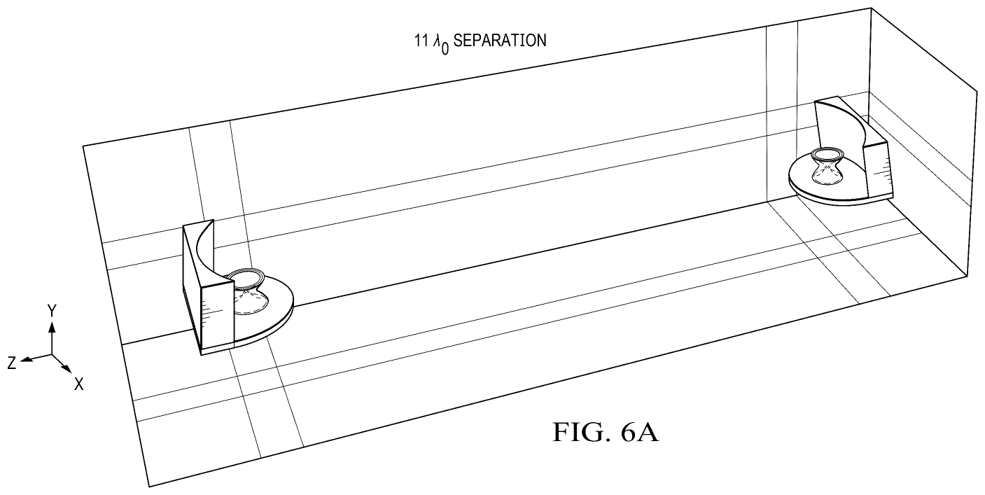

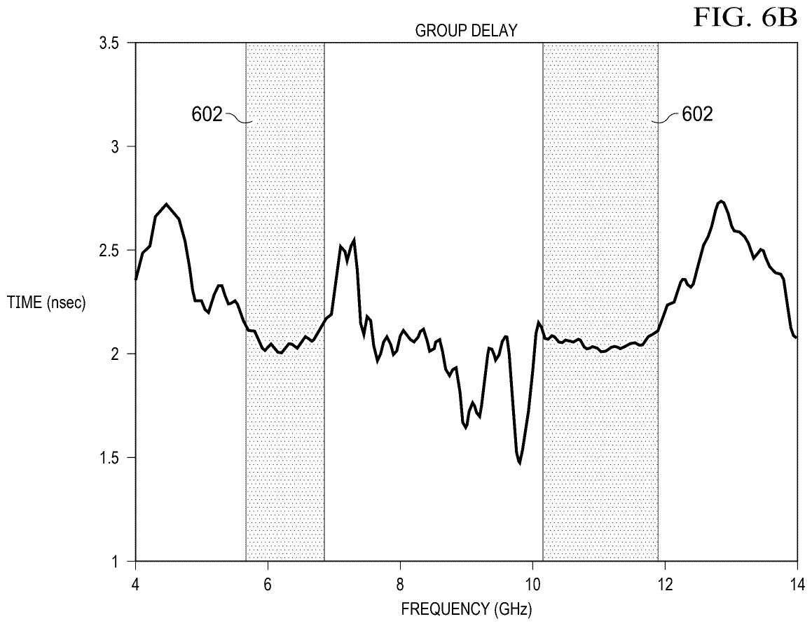

Referring now to FIGS. 6A and 6B, the distortion provided by the antenna 202 and reflector 204 combination described herein. The described antenna 202 and reflector 204 combination pair provides for low distortion in various bandwidths where the group delay is flat. This enables the antenna to provide a low distortion broadband capability. The antenna-to-antenna separation in FIG. 6A is 11 λ₀, and the two boxed regions 602 in FIG. 6B around 6 and 11 GHz show where distortion is minimized.

Thus, the biconical feed antennas described herein in normal operation without a connected reflector provides wideband full 360° azimuthal omni-directional coverage. By using a tilted parabolic reflector, various wide azimuthal beamwidths can be provided as a high gain antenna. The antenna is reconfigurable by removing the antenna from one reflector and placing the antenna within a second reflector so that various types of azimuthal beamwidths may be provided. By tilting the reflector wall with respect to the ground plane of the reflector, the elevation pattern of the beamwidth may be forced to the horizon. The reflector plus biconical antenna has a better than 15 dB return loss in the desired bandwidths, and the provided patterns have around 10 dB of gain within the desired bandwidths shown.

Although the preferred embodiment has been described in detail, it should be understood that various changes, substitutions and alterations can be made therein without departing from the spirit and scope of the invention as defined by the appended claims.

What is claimed is:

1. An apparatus comprising:
a biconical antenna for generating an omnidirectional beam pattern;
a first removable reflector for reflecting the omnidirectional beam pattern from the biconical antenna as a first predetermined beamform; and
wherein the first removable reflector having the first predetermined beamform is configured to be removed from the biconical antenna and replaced with a second removable reflector providing a second predetermined beamform.

2. The apparatus of claim 1, wherein the biconical antenna comprises a pair of metallized cones having a sinusoidal taper on the pair of cones, the pair of cones are connected at a small end of the pair of cones.

3. The apparatus of claim 2 further comprising a dielectric material surrounding the pair of cones.

4. The apparatus of claim 1, wherein the first removable reflector further comprises:
a ground plane connected to the biconical antenna;
a parabolic reflector extending from the ground plane at a predetermined angle;
wherein a curvature of the parabolic reflector reflects the omnidirectional beam pattern in the first predetermined beam form.

5. The apparatus of claim 4, wherein the predetermined angle corrects for beam shift of the first predetermined beam form caused by the ground plane.

6. The apparatus of claim 4, wherein the first predetermined beam is directed upward from horizontal responsive to the ground plane and the first predetermined beam is directed downward responsive to the predetermined angle of the parabolic reflector such that combined effect of the ground plane and the predetermined angle of the parabolic reflector provides the first predetermined beam substantially horizontally from the apparatus.

7. The apparatus of claim 1, wherein the biconical antenna further comprises a coaxially fed radiating element for emitting an RF signal.

8. A method comprising:
generating an omnidirectional beam pattern using a biconical antenna;
reflecting the omnidirectional beam pattern from the biconical antenna as a first predetermined beamform using a first removable reflector;
removing the first removable reflector from the biconical antenna; and
replacing the first removable reflector with a second removable reflector providing a second predetermined beamform.

9. The method of claim 8 further comprising extending a parabolic reflector of the first removable reflector from a ground plane of the reflector at a predetermined angle.

10. The method of claim 9, wherein the step of reflecting the first predetermined beam further comprises directing the first predetermined beam downward responsive to the predetermined angle of the parabolic reflector such that combined effect of the ground plane directing the first predetermined beam upward and the predetermined angle of the parabolic reflector provides the first predetermined beam substantially horizontally from the first removable reflector.

11. The method of claim 8 further comprises emitting an RF signal from a coaxially fed radiating element in the biconical antenna.

12. An apparatus comprising:
a biconical antenna for generating an omnidirectional beam pattern;
a first removable reflector for reflecting the omnidirectional beam pattern from the biconical antenna as a first predetermined beamform, wherein the first removable reflector further comprises:
a ground plane connected to the biconical antenna;
a parabolic reflector extending from the ground plane at a predetermined angle, wherein the predetermined angle corrects for beam shift of the first predetermined beam form caused by the ground plane;
wherein a curvature of the parabolic reflector reflects the omnidirectional beam pattern in the first predetermined beam form; and
wherein the first removable reflector having the first predetermined beamform is configured to be removed from the biconical antenna and replaced with a second removable reflector providing a second predetermined beamform.

13. The apparatus of claim 12, wherein the biconical antenna comprises a pair of metallized cones having a sinusoidal taper on the pair of cones, the pair of cones are connected at a small end of the pair of cones.

14. The apparatus of claim 13 further comprising a dielectric material surrounding the pair of cones.

15. The apparatus of claim 12, wherein the first predetermined beam is directed upward from horizontal responsive to the ground plane and the first predetermined beam is directed downward responsive to the predetermined angle of the parabolic reflector such that combined effect of the ground plane and the predetermined angle of the parabolic reflector provides the first predetermined beam substantially horizontally from the apparatus.

16. The apparatus of claim 12, wherein the biconical antenna further comprises a coaxially fed radiating element for emitting an RF signal.
